(19) United States
(12) Patent Application Publication
(10) Pub. No.: US 2026/0104099 A1
(43) Pub. Date: Apr. 16, 2026

(54) Tube lifter with ventilation valve

(71) Applicant: J.Schmalz GmbH, Glatten (DE)

(72) Inventors: Hans Burt, Horb a.N. (DE); Alex Marchel, Dornstetten (DE)

(21) Appl. No.: 19/302,685

(22) Filed: Aug. 18, 2025

(30) Foreign Application Priority Data
Aug. 19, 2024 (DE) 10 2024 123 584.5

(51) Int. Cl. F16K 11/16; B65G 47/91

(52) U.S. Cl. CPC F16K 11/168; B65G 47/91

(57) ABSTRACT

The invention relates to a ventilation valve for a tube lifter, as well as to a tube lifter comprising such a ventilation valve, and to an operating device for a tube lifter comprising such a ventilation valve.

### FIELD OF THE DISCLOSURE

The invention relates to a ventilation valve for a tube lifter, a tube lifter with such a ventilation valve, and an operating device for a tube lifter with such a ventilation valve.

### BACKGROUND OF THE DISCLOSURE

Tube lifters are vacuum handling devices by means of which loads can be lifted, optionally moved and then set down again by means of a vacuum. The lifting force is exerted by means of a lifting tube which can be shortened by applying a vacuum to the tube interior thereof and can be lengthened again by releasing the vacuum prevailing therein. An end effector for gripping an object is usually arranged at one end of the lifting tube. This can be a mechanical gripping device, but in particular a suction gripping device.

In order to operate the lifting tube and/or the end effector, an operating device is usually provided between the lifting tube and the end effector, which has an operating handle for moving the lifting tube. The operating device usually has an integrated ventilation valve, by means of which the interior of the lifting tube can be ventilated as required and thus its length can be changed. A switch or button is usually provided on the operating device to open the ventilation valve.

DE 10 2008 028 205 C5 discloses an operating device of this kind for tube lifters comprising a handle which has a manually actuatable trigger. The trigger controls a ventilation valve through which an inflow of ambient air into the lifting tube is controlled. Specifically, when the trigger is actuated, air is supplied to the lifting tube from the surroundings of the lifting tube, as a result of which the pressure in the tube interior is increased and the lifting tube can subsequently extend, possibly under the effect of gravity. If the trigger is released, the ventilation valve closes again, so that an inflow of ambient air into the lifting tube is interrupted, as a result of which the lifting tube automatically contracts again in the direction of its end position.

However, this automatic movement into the end position is not always desired. Instead, it can be advantageous if the tube lifter does not move into the end position but remains at a preset suspended height, for example in order to be able to grasp the operating device for preparing a next transport process of a workpiece from this working height.

### Summary of the Disclosure

For this purpose, it is known to provide a separate latching lever on the operating device, which locking lever locks the trigger in a defined switching position and thus allows a defined inflow of ambient air.

For example, an operating device with an operating handle is known from DE 10 2020 128 380 A1, a button for opening a ventilation valve being provided on a first side of the operating handle. The ventilation valve is acted upon into a closed position by means of an energy accumulator, so that after

the button is released, the ventilation valve is transferred into the closed position and the button thus returns to its original position. In order to lock the ventilation valve in an intermediate position between the closed position and the open position, a locking mechanism is provided which can be released via a release button located on the opposite side of the operating handle.

In order to make the operation of a tube lifter even more intuitive, it is known from DE 10 2023 102 438 B3 to provide two operating elements, the ventilation valve being opened when the first operating element is actuated and the ventilation valve being closed when the second operating element is actuated. The ventilation valve is designed here as a valve flap, on which the operating elements act directly via a respective transmission element in the form of a connecting rod. The valve flap is preferably centrally mounted such that no movement force is exerted on the valve flap even when a vacuum is applied on one side, which reduces the risk of unintentional actuation of the valve flap and thus allows for suspension control.

The invention is based on the object of improving the ventilation of a tube lifter in a structurally simple manner. In particular, a suspension state should be easy to set.

This object is achieved according to the invention by a ventilation valve having the features of claim 1, by a tube lifter having the features of claim 12, and by an operating device having the features of claim 16.

According to a first aspect, a ventilation valve is proposed. The ventilation valve is in particular suitable for ventilating a lifting tube of a tube lifter. The ventilation valve has a negative pressure side and a ventilation side, in particular a positive pressure side. When used in a tube lifter, the negative pressure side is in particular fluidly connected to a tube interior of a lifting tube of the tube lifter. The ventilation side is in particular connected to the atmosphere. The ventilation valve also comprises a valve mechanism, in particular arranged between the negative pressure side and the ventilation side, for opening and closing a flow connection between the negative pressure side and the ventilation side. The valve mechanism comprises a first valve body device and a second valve body device. Preferably, the first valve body device comprises at least one first valve body, e.g. valve piston. Preferably, the second valve body device comprises at least one second valve body, e.g. valve piston. The first valve body device, in particular the at least one first valve body, is adjustable in a first switching direction, in particular linearly, starting from a closed position into an open position. The second valve body device, in particular the at least one second valve body, is adjustable in a second switching direction, in particular linearly, starting from a closed position into an open position. The valve body devices are motion-coupled to each other in such a way that in the case of a movement of the first valve body device in the first switching direction (i.e. towards the open position) the second valve body device is moved in the second switching direction (i.e. towards the open position) and vice versa.

Preferably, the valve mechanism, in particular the valve body devices, is designed such that, when there is a pressure difference between the negative pressure side and the ventilation side, at least in the closed position, a first force acting in the first switching direction is exerted on the first valve body device and a second force acting opposite to the second switching direction is exerted on the second valve body device. Preferably, the valve mechanism, in particular the valve body devices, is designed such that the first force and the second force differ from each other in terms of amount by a maximum of 10%, preferably a maximum of 5%, more preferably a maximum of 1%.

Preferably, the valve body devices, in particular the valve bodies, each have first active surface portions, by applying pressure to which a force is exerted on the respective valve body device in the respective switching direction, and in each case second active surface portions, by applying pressure to which a force is exerted on the respective valve body device counter to the respective switching direction. The valve body devices, in particular the valve bodies, are then preferably dimensioned such that a difference between the sum of all first active surface portions of the first valve body device, in particular of the at least one first valve body, and the sum of all second active surface portions of the first valve body device, in particular of the at least one first valve body, differs in amount from one of the difference between the sum of all first active surface portions of the second valve body device, in particular of the at least one second valve body, and the sum of all second active surface portions of the second valve body device, in particular of the at least one second valve body, by a maximum of 10%, preferably a maximum of 5%, more preferably a maximum of 1%. Preferably the differences are identical.

Preferably, the valve mechanism is designed in such a way, in particular the valve body devices are dimensioned in such a way, that when there is a pressure difference between the negative pressure side and the ventilation side, the first valve body device is acted upon in the first switching direction and the second valve body device is acted upon counter to the second switching direction in such a way that the valve body devices remain in their current position as a result of the motion coupling.

In this respect, such a ventilation valve has an at least substantially pressure-balanced valve mechanism, which on the one hand promotes simple, in particular force-saving, actuation of the ventilation valve and on the other hand prevents automatic adjustment of the valve mechanism due to a pressure difference between the negative pressure side and the ventilation side. This makes it possible to create a suspended state in a structurally simple and compact manner when using the ventilation valve in a tube lifter.

In the closed position, the valve body devices rest in particular against a respective valve seat. In the open position, the valve body devices are in particular lifted off a respective valve seat. Preferably, in the closed position, the valve body devices each close a flow opening between the ventilation side and the negative pressure side, and in the open position this flow opening is at least partially open.

Preferably, the ventilation valve comprises a valve housing. The valve mechanism, in particular the first and/or the second valve body device, can then be arranged in the valve housing. The valve housing may have a negative pressure chamber forming the negative pressure side and a ventilation chamber forming the ventilation side. When installed in a tube lifter, the negative pressure chamber can be fluidically connected to the tube interior of the lifting tube of the tube lifter. The ventilation chamber can be fluidly connected to a ventilation connection of the tube lifter.

The valve bodies can be designed in different ways. In particular, the valve bodies can be designed as valve pistons. Such a design enables a particularly compact structure. In addition, sealing is easier compared to solutions with valve flaps, for example.

The valve bodies, in particular the valve pistons, can have different cross-sectional shapes. The valve bodies, in particular valve pistons, can be rotationally symmetrical. For example, the valve bodies can have a circular cross-section. The valve bodies can also have a square cross-section.

The valve bodies can have one or more sealing elements, e.g. in the form of sealing rings. It is also conceivable that the sealing element is arranged on a respective valve seat with which the valve body interacts in the closed position.

The first valve body device and the second valve body device can be designed identically to one another. The first valve body device and the second valve body device can also be designed differently.

It is conceivable that the first valve body device and the second valve body device each comprise only one valve body, in particular valve piston.

It is also conceivable that the first valve body device and/or the second valve body device has more than one valve body.

The valve body devices may have the same number of valve bodies, for example each valve body device may have two valve bodies.

The valve body devices can also have a different number of valve bodies. For example, it is conceivable that one of the valve body devices has only one valve body and the other valve body device has more than one valve body.

Preferably, each valve body device, in particular each valve body, is assigned at least one separate flow opening between the negative pressure side and the ventilation side. Preferably, the valve body devices, in particular the valve bodies, then cooperate with a respective valve seat in the respective closed position in order to seal off the at least one flow opening assigned to them. In this respect, the first valve body device can cooperate with a first valve seat in the closed position in order to close a first flow opening between the ventilation side and the negative pressure side, and the second valve body device can cooperate with a second valve seat in the closed position in order to close a second flow opening between the ventilation side and the negative pressure side.

It proves to be particularly advantageous if the valve body devices, in particular the valve bodies, extend into the at least one flow opening assigned to them, along the switching direction, so that at least in an opened position [i.e. a position between the closed position and the open position] a ventilation gap is formed between the respective valve body device, in particular the valve body, and a wall delimiting the flow opening. In this respect, the valve body devices can be arranged at least in portions in a respective flow opening between the ventilation side and the negative pressure side, so that at least in an opened position a ventilation gap is formed between the valve body device, in particular the valve body, and a wall delimiting the flow opening.

In the context of an advantageous embodiment, the negative pressure side and the ventilation side are separated from each other by a wall, in particular of the valve housing. In an embodiment with a valve housing, the wall can divide a valve interior of the valve housing into the negative pressure side, in particular into the negative pressure chamber, and the ventilation side, in particular into the ventilation chamber.

Preferably, at least one first flow opening is formed in the wall, through which the first valve body device, in particular the at least one first valve body, extends, and at least one second flow opening through which the second valve body device, in particular the at least one second valve body, extends. The flow openings are preferably designed as recesses in the wall. The wall, in particular a wall portion surrounding the respective flow opening, can then form a valve seat for the valve body devices, in particular the valve bodies.

In particular, a sealing device, for example in the form of an O-ring or a sealing strip, can be arranged in each case between the wall and the valve body device. The sealing device can be arranged on the valve body device and thus be displaceable together therewith as part of the valve body device. The sealing device can also be arranged stationary on the wall.

The valve body devices are preferably arranged on opposite sides of the wall. In particular, the first valve body device is arranged on the negative pressure side of the wall and the second valve body device is arranged on the ventilation side of the wall.

Preferably, the Valve Body Devices, in Particular the Valve bodies, extend from opposite sides through the flow openings.

Preferably, the valve body devices are designed such that the wall forms a stop for the valve body devices in the respective closed position, i.e. limits a movement path of the valve body device in a direction counter to the switching direction. This prevents the valve body devices from being able to slip through to the opposite side of the wall.

Within the scope of a particularly advantageous development, the valve body devices can be designed in such a way, in particular the valve bodies can be shaped in such a way, further in particular the valve bodies can taper radially in a direction counter to the respective switching direction in such a way, that with a respective adjustment movement of the valve body devices, in particular of the valve bodies, in the switching direction, a flow cross-section for flows from the ventilation side to the negative pressure side, in particular the size of a ventilation gap formed between the valve body device and the valve seat, changes non-linearly, in particular increases progressively (i.e. with increasing degree of opening an increase in the flow cross-section per unit stroke along the switching direction increases). Such an embodiment enables particularly precise control. When the ventilation valve is used in a tube lifter, particularly intuitive and safe operation can thus be achieved.

Such a non-linear opening can be realized, for example, by the valve bodies tapering radially in a direction counter to the switching direction, in particular in a funnel-shaped or cup-shaped manner.

Furthermore, it may prove advantageous if the valve bodies taper radially, in particular linearly, in the switching direction. In this way, a particularly advantageous flow pattern can be achieved in order to minimize the force effect of a volume flow on the valve body.

In a first advantageous embodiment of the ventilation valve according to the first aspect, the first switching direction and the second switching direction can be oriented in opposite directions. In this respect, the valve body devices, in particular the valve bodies, can move in opposite directions from an open position towards a closed position. In this respect, the valve body devices can move in opposite directions.

The first and second valve body devices are then in particular designed and motion-coupled to one another in such a way that they can move relative to one another.

The valve body devices can be coupled to one another in different ways. For example, the valve body devices could be hydraulically motion-coupled to one another. Preferably, the valve body devices are mechanically motion-coupled to one another.

Advantageously, the first valve body device and the second valve body device can be motion-coupled to one another via a rotatably mounted coupling element, in particular in the manner of a rocker. The coupling element can be designed as a coupling rod, for example. In this case, an axis of rotation of the coupling element is preferably arranged between the first and the second valve body device.

The coupling element has in particular a first coupling portion for connection to the first valve body device and a second coupling portion for connection to the second valve body device. The first and/or the second coupling portion can be designed as an elongate hole. The first and/or the second coupling portion can also be designed as pins which engage in a corresponding elongate hole on the first or second valve body device.

Furthermore, it may prove advantageous if one of the two coupling portions is designed as a fork. This promotes particularly simple assembly.

In connection with the first embodiment, it also proves to be advantageous if the first and second switching directions are arranged parallel to a main flow direction from the ventilation side to the negative pressure side.

Within the scope of an advantageous development of the first embodiment, the valve mechanism can be designed in such a way, in particular a geometric arrangement of the valve body and the coupling element can be designed in such a way, that when the valve body devices are transferred into the closed position, one of the valve body devices reaches its closed position before the other valve body device reaches its closed position. In this respect, the valve mechanism can be designed in such a way, in particular a geometric arrangement of the valve body and the coupling element can be designed in such a way, that the valve body devices close one after the other, i.e. are transferred one after the other into their respective closed position. In particular, the valve body device whose switching direction points from the ventilation side to the negative pressure side can reach the closed position first. In this way, a negative pressure prevailing on the negative pressure side can close the valve body devices, which promotes compensation of design play.

In a second embodiment of the ventilation valve according to the first aspect, the first switching direction and the second switching direction can be oriented parallel to one another or can be identical.

For example, the first valve body device, in particular the at least one first valve body, and the second valve body device, in particular the at least one second valve body, can be rigidly connected to one another via a connecting element.

It is also conceivable that the first valve body device, in particular the at least one first valve body, and the second valve body device, in particular the at least one second valve body, are formed by different portions of a common valve body.

In the second embodiment, it has proven advantageous if the switching directions are arranged inclined, in particular orthogonally, to a main flow direction from the ventilation side to the negative pressure side. When used in a tube lifter, the ventilation valve is preferably arranged such that the switching directions are arranged orthogonally to a direction of action of gravity/horizontally. This prevents gravity from acting along the switching directions and the ventilation valve from adjusting itself.

According to a second aspect, a ventilation valve, in particular for a tube lifter, is proposed, comprising:
a ventilation opening, in particular connected to the atmosphere, and a negative pressure opening
a valve mechanism for opening and closing a flow connection between the ventilation opening and the negative pressure opening, comprising a valve body rotatably mounted about an axis of rotation, in particular in the form of a drum,
   the valve body having at least one radial through-opening, the valve body being arranged in a flow path between the ventilation opening and the negative pressure opening in such a way that the valve body, in a first rotational position about the axis of rotation, assumes a closed position in which a flow connection between the ventilation opening and the negative pressure opening is interrupted by the valve body, and the valve body, in a second rotational position different from the first rotational position, assumes an open position in which the flow connection between the ventilation opening and the vacuum opening through the at least one through-opening is established.

Such a design of a ventilation valve has proven to be particularly robust. In particular, if the axis of rotation is arranged inclined or orthogonally to a main flow direction from the ventilation opening to the negative pressure opening, displacement of the valve body solely by the flow force can be prevented. When used in a tube lifter, for example, a suspended state of the tube lifter can be realized in this way in a simple manner and in particular without an additional locking mechanism.

Within the scope of an advantageous embodiment, the ventilation valve according to the second aspect can have an, in particular disc-shaped, valve housing which delimits a valve interior. The valve interior preferably has at least one first opening, in particular a first housing opening of the valve housing, which forms the negative pressure opening, and at least one second opening, in particular at least one second housing opening of the valve housing, which forms the negative pressure opening.

Preferably, the at least one through-opening of the valve body in the second rotational position overlaps at least partially with both the at least one first opening and the at least one second opening. In particular, the at least one through-opening in the valve body is aligned with the at least one first opening and the at least one second opening in the second rotational position.

The ventilation valves described above according to the first and second aspects can generally be used for negative pressure applications, for example for ventilating a suction gripper or a negative pressure generating device. However, a particularly advantageous field of application is the field of tube lifters.

In this respect, the invention also relates to a tube lifter comprising a lifting tube with a tube interior and a ventilation valve for ventilating the tube interior. The lifting tube can be shortened by applying negative pressure to the tube interior and can be lengthened again by ventilating the tube interior.

The ventilation valve can be designed according to the first aspect. In this respect, according to a third aspect, a tube lifter is proposed, comprising
a lifting tube with a tube interior, the lifting tube being able to be shortened by applying negative pressure to the tube interior and being able to be lengthened again by ventilating the tube interior;
(optionally): an end effector, in particular in the form of a suction gripping device, for gripping an object
(optionally): an operating device arranged between the lifting tube and the end effector;
a ventilation valve for ventilating the tube interior of the lifting tube, comprising
   a negative pressure side connected to the tube interior,
   a ventilation side connected to the atmosphere
   a valve mechanism for opening and closing a flow connection between the negative pressure side and the ventilation side, comprising a first valve body device with at least one first valve body and a second valve body device with at least one second valve body, the first valve body device being adjustable in a first switching direction starting from a closed position into an open position, the second valve body device being adjustable in a second switching direction starting from a closed position into an open position, the valve body devices being coupled to one another in such a way that when the first valve body device moves in the first switching direction [i.e. in the direction of the open position], the second valve body device is moved in the second switching direction [i.e. in the direction of the open position] and vice versa, the valve mechanism (16), in particular the valve body devices (34-1, 34-2), being designed in such a way that, when there is a pressure difference between the negative pressure side (12) and the ventilation side (14), at least in the closed position, a first force acting in the first switching direction (38-1) is exerted on the first valve body device (34-1) and a second force acting counter to the second switching direction (38-2) is exerted on the second valve body device (34-2), the valve mechanism (16), in particular the valve body devices (34-1, 34-2), being designed such that the first force and the second force differ from each other in terms of amount by a maximum of 10%, preferably a maximum of 5%, more preferably a maximum of 1%, in particular are identical.

The optional features and advantages described above in connection with the ventilation valve according to the first aspect can also serve to design the tube lifter according to the third aspect, so that reference is made to the above disclosure in this respect in order to avoid repetition.

The ventilation valve can be positioned at a lower end of the lifting tube (e.g. on an operating device) as well as at the top of the lifting tube.

The ventilation valve of the tube lifter can also be designed according to the second aspect. In this respect, according to a fourth aspect, a tube lifter is proposed, comprising:
a lifting tube with a tube interior, the lifting tube being able to be shortened by applying negative pressure to the tube interior and being able to be lengthened again by ventilating the tube interior;
(optionally): an end effector, in particular in the form of a suction gripping device, for gripping an object
(optionally): an operating device arranged between the lifting tube and the end effector;
a ventilation valve for ventilating the tube interior of the lifting tube, comprising
   a negative pressure opening that is in flow connection with the tube interior of the lifting tube
   a ventilation opening, in particular connected to the atmosphere, and
   a valve body that is rotatably mounted about an axis of rotation, in particular in the form of a drum, the valve body having at least one radial through-opening, the valve body being arranged in a flow path between the ventilation opening and the negative pressure opening in such a way that the valve body, in a first rotational position about the axis of rotation, assumes a closed position in which a flow connection between the ventilation opening and the negative pressure opening is interrupted by the valve body, and the valve body, in a second rotational position different from the first rotational position, assumes an open position in which the flow connection between the ventilation opening and the vacuum opening through the at least one through-opening is established.

The optional features and advantages described above in connection with the ventilation valve according to the second aspect can also serve to design the tube lifter according to the fourth aspect, so that reference is made to the above disclosure in this respect in order to avoid repetition.

The following optional features and advantages can be used both to design the tube lifter according to the third aspect and to design the tube lifter according to the fourth aspect:

The end effector can be able to be supplied with a negative pressure through the tube interior of the lifting tube.

The operating device can be arranged at one end of the lifting tube. The operating device can have an operating handle, in particular one that can be gripped with one hand. The operating device may have an end effector coupling for coupling an end effector.

The ventilation valve can be arranged in the operating device. The operating device can have a lifting tube connection that is fluidly connected to the tube interior. Then, the negative pressure side of the ventilation valve (first aspect) or the negative pressure opening (second aspect) can be fluidly connected to the lifting tube connection.

The tube lifter can have an operating mechanism for actuating the ventilation valve, in particular for adjusting the valve mechanism between the closed position and the open position or for adjusting a rotational position of the valve body.

Preferably, the operating mechanism is arranged on the operating device.

According to a fifth aspect, an operating device for a tube lifter is proposed, comprising:
a lifting tube connection for flow connection with a tube interior of a lifting tube of the tube lifter;
an end effector coupling for coupling the end effector to the operating device;
a ventilation valve according to the first aspect or the second aspect,
an operating mechanism for actuating the ventilation valve, in particular for adjusting the valve mechanism between a closed position and open positions or for adjusting a rotational position of the valve body.

The operating mechanism preferably comprises: a first operating element which is adjustable along a first actuation direction, a second operating element which is adjustable along a second actuation direction, and a coupling device via which the operating elements are mechanically coupled to the ventilation valve. In an embodiment of the ventilation valve according to the first aspect, the operating elements are preferably mechanically coupled to the valve mechanism in such a way that by adjusting the first operating element in the first actuation direction, the valve mechanism is adjusted in the direction of the open position, and by adjusting the second operating element in the second actuation direction, the valve mechanism is adjusted in the direction of the closed position. Preferably, the coupling device engages on one of the two valve body devices. In an embodiment of the ventilation valve according to the first aspect, the operating elements are preferably mechanically coupled to the valve mechanism in such a way that by adjusting the first operating element in the first actuation direction, the valve body is transferred into the first rotational position, and by adjusting the second operating element in the second actuation direction, the valve body is transferred into the second rotational position.

### BRIEF DESCRIPTION OF THE DRAWINGS

The invention is explained in more detail below with reference to the figures. In the drawings:

FIG. 1 is a sketched sectional view of an embodiment by way of example of a first implementation of the ventilation valve with the valve mechanism in the closed position;

FIG. 2 shows the ventilation valve according to FIG. 1 with the valve mechanism in the open position;

FIG. 3 is a sketch of the valve mechanism of the ventilation valve according to FIG. 1;

FIG. 4 is a simplified schematic sectional view of an embodiment by way of example of a second implementation of the ventilation valve with the valve mechanism in the open position;

FIG. 5 is a sketch of an embodiment of a tube lifter;

FIG. 6 is a sketch of the operating device of the tube lifter according to FIG. 5 with a coupled end effector;

FIG. 7 is a sectional view of the operating device according to FIG. 5;

FIG. 8 is a sketched sectional view of a module of the operating mechanism of the operating device according to FIG. 7;

FIG. 9 is an exploded view of the module according to FIG. 8;

FIG. 10 is a sketched perspective view of a further embodiment of a ventilation valve with optional operating mechanism; and

FIG. 11 is a side view of the ventilation valve according to FIG. 10.

### DETAILED DESCRIPTION OF THE DRAWINGS

In the following description and in the figures, identical reference signs are in each case used for identical or corresponding features.

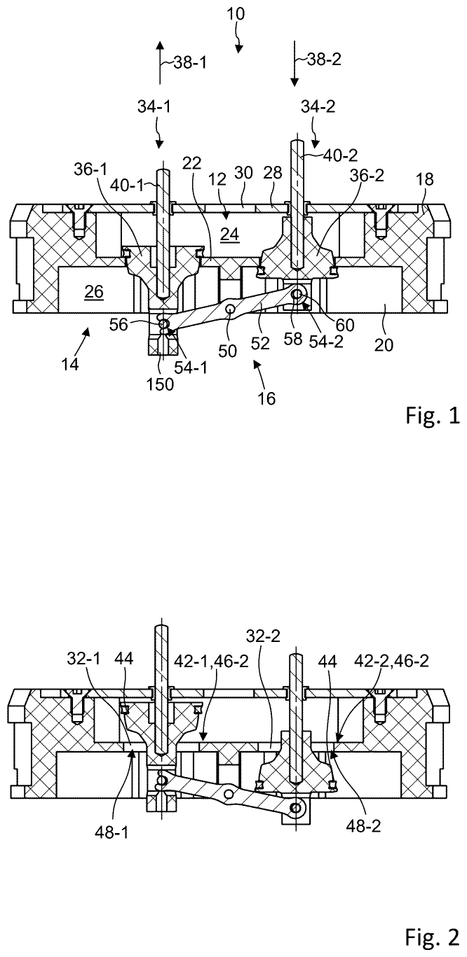

FIG. 1 is a sketch of an embodiment by way of example of a first implementation of a ventilation valve, which is denoted as a whole by reference sign 10.

The ventilation valve 10 has a negative pressure side 12 and an opposing ventilation side 14. The ventilation valve 10 also has a valve mechanism 16, arranged in the example between the negative pressure side 12 and the ventilation side 14, for opening and closing a flow connection between the negative pressure side 12 and the ventilation side 14.

In the example, the ventilation valve 10 has a valve housing 18 which defines a valve interior 20. The valve interior 20 is divided by a wall 22 of the valve housing 18 into a first chamber 24 (negative pressure chamber) and a second chamber 26 (ventilation chamber).

In operation, the negative pressure chamber 24 is in particular connected to a negative pressure source (not shown). When the ventilation valve 10 is used in a tube lifter 100, the negative pressure side 12 is connected, for example, to the tube interior of a lifting tube 102 of the tube lifter 100.

In the specific example, the negative pressure chamber 24 is delimited by a cover plate 28, which has a through-opening 30 for connection to the negative pressure source.

The ventilation chamber 26 is connected to the atmosphere. For example, the ventilation chamber 26 may be fluidly connected to a ventilation connection 128 (see below).

As can be seen from FIG. 2, two flow openings 32-1, 32-2 are formed in the wall 22, which—in an open position of the valve mechanism (explained in more detail below)—establish a flow connection between the ventilation side 26 and the negative pressure side 24.

The valve mechanism 16 comprises a first valve body device 34-1, which cooperates with the first flow opening 32-1, and a second valve body device 34-2, which cooperates with the second flow opening 32-2.

In the example shown, each of the valve body devices 34-1, 34-2 has a valve body 36-1, 36-2. As can be seen from FIGS. 1 and 2, the valve bodies 36-1, 36-2 extend through the respectively associated flow opening 32-1, 32-2.

The valve bodies 36-1, 36-2 are adjustable between a closed position (see FIG. 1) and an open position (see FIG. 2). Specifically, the first valve body 36-1 is adjustable in a first switching direction 38-1 from the closed position to the open position, and the second valve body 36-2 is adjustable in a second switching direction 38-2 from its closed position to the open position.

As can be seen from FIG. 1, in the embodiment shown, the first switching direction 38-1 and the second switching direction 38-2 are oriented in opposite directions. In this respect, the first valve body 36-1 of the first valve body device 34-1 and the second valve body 36-2 of the second valve body device 34-2 move in opposite directions from the respective closed position to the respective open position.

By way of example and preferably, the switching directions 38-1, 38-2 are aligned parallel to a main flow direction for flows from the ventilation side 14 to the negative pressure side 12.

In the specific example, the valve bodies 36-1, 36-2 are each guided via a respective guide pin 40-1, 40-2 along the respective switching direction 38-1, 38-2. The guide pins 40-1, 40-2 are, by way of example, axially guided in the cover plate 28 mentioned above.

As can be seen from FIG. 1, in the respective closed position the valve bodies 36-1, 36-2 rest against a valve seat 42-1, 42-2, which in the example is formed by a wall portion of the wall 22 defining the respective flow opening 32-1, 32-2. For sealing purposes, corresponding sealing elements 44, for example in the form of O-rings, are arranged on the valve bodies 36-1, 36-2. In embodiments not shown, the sealing elements 44 can also be arranged on the valve seats 42-1, 42-2.

As can be seen from FIG. 2, the valve bodies 36-1, 36-2 are lifted off the respective valve seat 42-1, 42-2 in the open position, so that a ventilation gap 48-1, 48-2 is formed between the valve body 36-1, 36-2 and a wall portion 46-1, 46-2 of the wall 22 defining the respective flow opening 32-1, 32-2, through which gap a flow leads when there is a pressure difference between the negative pressure side 12 and the ventilation side 14.

As mentioned above, the first valve body device 34-1 and the second valve body device 34-2 are motion-coupled to one another in such a way that when the first valve body 36-1 moves from the closed position into the open position, i.e. in the first switching direction 38-1, the second valve body 36-2 is also displaced from the closed position into the open position, i.e. in the second switching direction 38-1.

In the example, this is realized in that the first valve body 36-1 and the second valve body 36-2 are mechanically connected to one another via a coupling element 52, by way of example in the form of a coupling rod, which is mounted so as to be rotatable about an axis of rotation 50.

As can be seen from FIG. 1, the coupling element 52 is designed in the form of a fork at a first coupling portion 54-1 for connection to the first valve body 36-1, which fork cooperates with a bolt 56 arranged on the first valve body 36-1. On an opposite second coupling portion 54-2 for connection to the second valve body 36-2, the coupling element preferably has an elongate hole 58 into which a bolt 60 arranged on the second valve body 36-2 engages.

As mentioned above, the valve body devices 34-1, 34-2 are dimensioned such that when there is a pressure difference between the negative pressure side 12 and the ventilation side 14, the first valve body device 34-1 is acted upon in the first switching direction 38-1 and the second valve body device 34-2 is acted upon counter to the second switching direction 38-2, in such a way that the valve body devices 34-1, 34-2 remain in their current position as a result of the motion coupling.

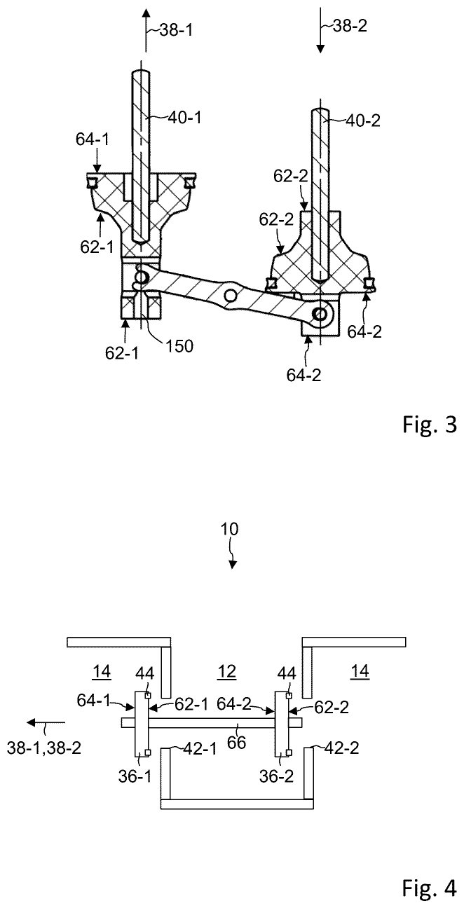

As shown in FIG. 3, in the specific example the valve bodies 36-1, 36-2 each have first active surface portions 62-1, 62-2, by applying pressure to which a force is exerted on the respective valve body 36-1, 36-2 along the respective switching direction 38-1, 38-2. In addition, the valve bodies 36-1, 36-2 each have second active surface portions 64-1, 64-2, by applying pressure to which a force is exerted on the respective valve body 36-1, 36-2 against the respective switching direction 38-1, 38-2. In this case, the valve bodies 36-1, 36-2 are dimensioned such that a difference between the sum of all first active surface portions 62-1 of the first valve body device 34-1 and the sum of all second active surface portions 64-1 of the first valve body device 34-1 differs from one of the differences between the sum of all first active surface portions 62-2 of the second valve body device 34-2 and the sum of all second active surface portions 64-2 of the second valve body device 34-2, in terms of amount, by a maximum of 10%, preferably a maximum of 5%, more preferably a maximum of 1%.

In the specific example, this is achieved by the valve bodies 36-1, 36-2 having an essentially identical outer contour. In embodiments that are not shown, however, it is also conceivable that the valve body devices 34-1, 34-2 each have more than one valve body 36-1, 36-2 and/or a different number of valve bodies 36-1, 36-2. Then, the valve bodies 36-1, 36-2 are preferably designed such that

As can be seen from FIG. 3, the valve bodies 36-1, 36-2 are optionally designed such that they taper radially along their extension opposite to the respective switching direction 38-1, 38-2, i.e. a diameter decreases along their extension opposite to the switching direction. When the valve bodies 36-1, 36-2 are displaced in the switching direction 38-1, 38-2, the size of the ventilation gap 48-1, 48-2 increases progressively in this respect.

FIG. 4 is a simplified schematic view of an embodiment by way of example of a second implementation of the ventilation valve, which is denoted as a whole by reference sign 10′.

Features that have already been explained in connection with the embodiment according to FIG. 1 to 3 will not be described again unless it is necessary for the particular embodiment according to FIG. 4. Identical or equivalent features are designated by the same reference signs.

As can be seen from FIG. 4, in the embodiment according to FIG. 4 the first valve body device 34-1 or the first valve body 36-1, and the second valve body device 34-2 or the second valve body 36-2, are rigidly connected to one another via a connecting element 66 and are thus motion-coupled. In contrast to the first implementation, in this respect the first and second switching directions 38-1, 38-2 are oriented in the same way, in the example even identically.

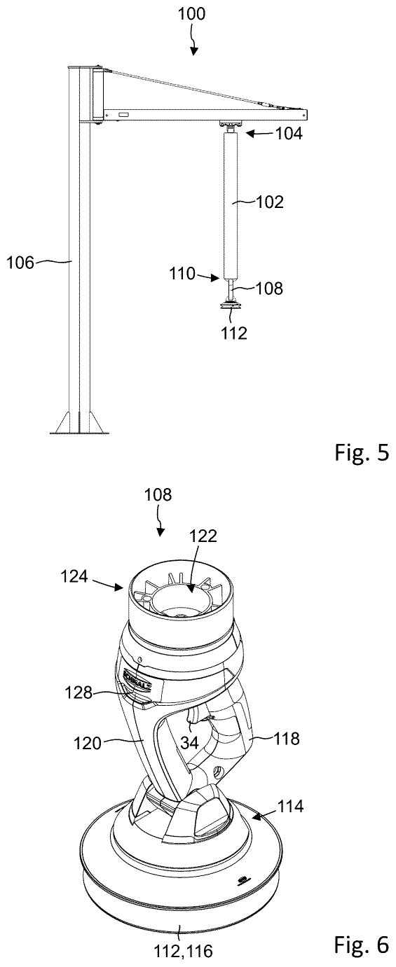

An application by way of example of the above-described ventilation valve 10 in a tube lifter 100 is explained below with reference to FIG. 5 to 9.

FIG. 5 shows an embodiment by way of example of a tube lifter, which is denoted as a whole by reference sign 100. The tube lifter 100 comprises a lifting tube 102, which encloses a tube interior. The lifting tube 102 can be shortened by applying a negative pressure to the tube interior 20 and can be extended again by ventilating the tube interior 20. In other words, depending on the pressure level in the tube interior 14, the lifting tube 102 is reversibly shortened or lengthened, for example under the effect of the weight force.

In the example, the lifting tube 102 is held at a first (upper) end 104 on a manipulator 106, for example in the form of a column jib crane, and can thus be displaced by the manipulator 106. In embodiments that are not shown, the lifting tube 102 can, however, also be mounted on a support, for example a scaffold or a building ceiling.

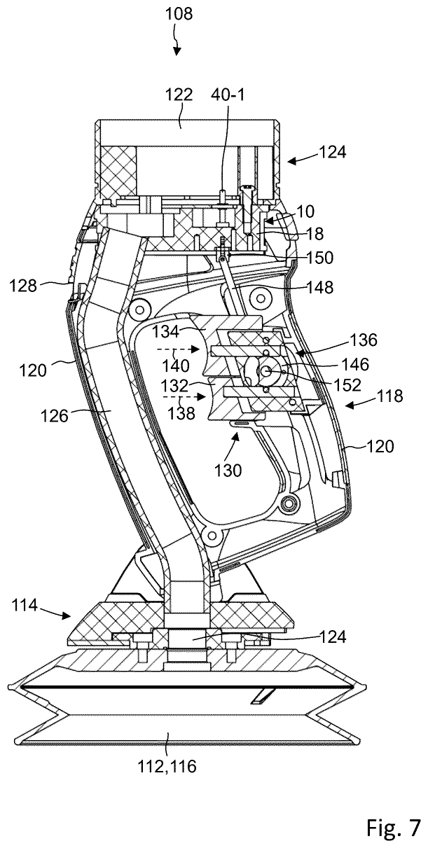

In order to operate the tube lifter 100, an operating device 108 is provided (detailed view cf. FIGS. 6 and 7). The operating device 108 is preferably held at the second (lower) end 110 of the lifting tube 102.

The tube lifter 100 also comprises an end effector 112 for gripping an object (not shown). The end effector 112 is mounted on the operating device 108 via an end effector coupling 114 formed on the operating device 108, and is thus connected to the lifting tube 102. By shortening the lifting tube 102, the end effector 112 and thus an object gripped by the end effector 112 can be lifted.

By way of example and preferably, the end effector 112 is designed as a suction gripping device 116 for suctioning an object. As explained in more detail below, in the example the end effector 112 can be supplied with negative pressure through the tube interior of the lifting tube 102. However, in embodiments that are not shown, the end effector 112 can also be designed for example as a hook or a mechanical gripper.

A preferred embodiment of the operating device 108 is explained in greater detail below with reference to FIGS. 6 and 7.

The operating device 108 comprises an operating handle 118 (handle), which is designed in particular in such a way that an operator can grip it using one hand. In this respect, the operating device 108 is in particular a single-hand operating device.

As can be seen in FIG. 7, the operating handle 118 is, by way of example and preferably, designed as a hollow body. Specifically, the operating handle 118 can be formed by a housing portion of a housing 120 of the operating device 108.

The operating device 108 additionally comprises a lifting tube connection 122 for fluidic connection to the tube interior 14 of the lifting tube 102 (cf. FIG. 6). The lifting tube connection 122 can in particular be part of a lifting tube coupling 124, which also comprises a connection device for mechanically connecting the operating device 108 to the lifting tube 102.

On a side opposite the lifting tube connection 122, the operating device 108 has the above-mentioned end effector coupling 114 for coupling the end effector 108 (cf. FIG. 6). The end effector coupling 114 can be designed, for example, as described in DE 10 2023 102 439.6, the disclosure of which is hereby incorporated by reference.

In the example, the end effector coupling 114 also comprises an optional suction connection 124 for fluidic connection to the end effector 112. By way of example, the suction connection 124 is fluidically connected to the lifting tube connection 18 by means of an optional tubular fluid guide 126 and can thus be supplied with negative pressure through the lifting tube 102. In embodiments that are not shown, such a fluid guide 126 may, however, also be omitted.

The operating device 108 also comprises a ventilation valve 10 described above for ventilating the lifting tube connection 122 and thus the tube interior of the lifting tube 102. The ventilation valve 10 is arranged within the housing 120 of the operating device 108 (cf. FIG. 7).

Specifically, the negative pressure side 12 of the ventilation valve 10 is fluidly connected to the lifting tube connection 122 and thus to the tube interior of the lifting tube 102. In contrast, the ventilation side 14 of the ventilation valve 10, is fluidly connected to a ventilation connection 128, in particular a ventilation opening, of the operating device 108 and thus to the environment (atmosphere). The ventilation connection 128 is formed, by way of example, by corresponding openings or apertures in the housing 120 (see FIG. 7).

In order to actuate the ventilation valve 10, an operating mechanism 130 is provided, by means of which the valve mechanism 160 can be adjusted between the closed position and the open position.

An embodiment by way of example of such an operating mechanism 130 is explained in more detail below with reference to FIG. 7. The operating mechanism 130 comprises a first operating element 132 and a second operating element 134. The operating mechanism 130 also comprises a coupling device 136, via which an actuating movement of the operating elements 132, 134 is transmitted to the valve mechanism 16 (explained in detail below).

The first operating element 132 is adjustable along a first actuation direction 138, and the second operating element 134 is adjustable along a second actuation direction 140. By way of example and preferably, the first and the second actuation directions 138, 140 are oriented parallel to one another.

As can be seen in FIG. 7, the first operating element 132 and the second operating element 134 are arranged, by way of example and preferably, next to one another on the same side of the operating handle 118. The operating handle 118 is preferably shaped in such a way that an operator can grip it using one hand and in this case can actuate the operating elements 132, 134 with this hand (e.g. the first operating element 132 with the middle finger and the second operating element 134 with the index finger).

Starting from a neutral position shown in FIG. 7, the operating elements 132, 134 are alternately adjustable into an actuating position (pressed in from the neutral position in the actuating direction) and a non-actuating position (pressed out from the neutral position counter to the actuating direction).

In this case, the first operating element 132 and the second operating element 134 are mechanically forcibly coupled via the coupling device 136 in such a way that when the first operating element 132 is transferred in the actuation direction 138 (i.e. when the first operating element 132 is actuated), the second operating element 134 is automatically transferred counter to the actuation direction 140 and vice versa.

As can be clearly seen from FIGS. 6 and 7, for example, the first operating element 132 is motion-coupled to a coupling element 146 via a first transmission element 142 in the form of a transmission pin, and the second operating element 134 is motion-coupled to said coupling element 146 via a second transmission element 144. The coupling element 146 is in turn motion-coupled to the valve mechanism 16 via a connecting element 148 in the form of a transmission bracket. In the specific example, the connecting element 148 engages on a corresponding connecting portion 150 of the first valve body 36-1 (see FIG. 1).

The coupling element 146 is mounted to be rotatable about an axis of rotation 152. In the specific example, the coupling element 146 is rotatably received in a guide portion or guide receptacle 154 of a guide part 156. The coupling element 146 is, by way of example and preferably, designed in the form of a drum 158.

The guide part 156 is in particular inserted into the operating handle 118 (housing 120) and fastened there. In embodiments that are not shown, the guide receptacle 154 can also be formed integrally with the housing 120. £ As can be seen from FIG. 4, the transmission elements 142, 144 engage eccentrically on the coupling element 146, in particular on opposite sides with respect to the axis of rotation 152.

This is realized, by way of example, in that the transmission elements 142, 144 have local recesses 160 which interact with bolts 162 provided on the coupling element 146. The bolts 162 are, by way of example, formed separately from the coupling element 146 and inserted into corresponding bores 164 in the coupling element 146. In embodiments that are not shown, the bolts 162 can also be formed integrally with the coupling element 146, for example by corresponding projections on the coupling element 146.

If the first operating element 132 is actuated, i.e. adjusted in the first actuation direction 138, this adjustment movement is transmitted via the first transmission element 142 to the coupling element 146, which then rotates about the axis of rotation 152 (counterclockwise in the illustration according to FIG. 8). This results in the second operating element 134 being adjusted counter to the second actuation direction 140 due to the motion coupling via the coupling element 146 and the second transmission element 144.

The first and the second operating elements 132, 134 are motion-coupled to one another via the coupling element 146 in such a way that the operating elements 132, 134 can alternately assume an actuation position and a non-actuation position.

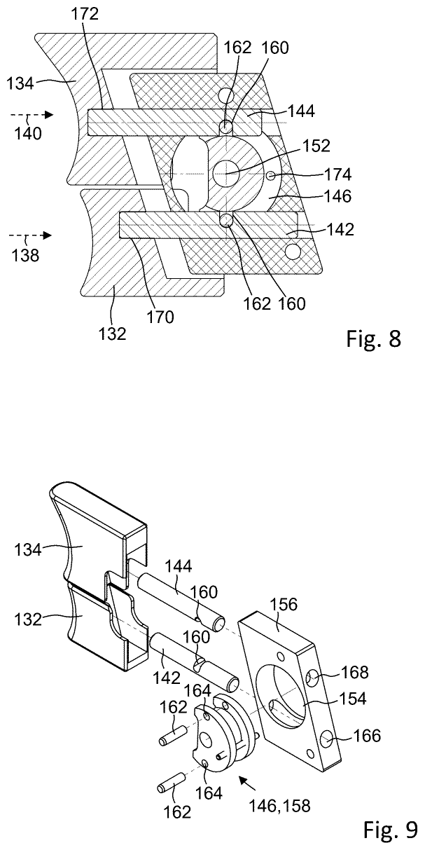

As can be seen from FIGS. 8 and 9, the transmission elements 142, 144 (transmission pins) are guided in corresponding guides 166, 168 (pin guides) in a linearly displaceable manner.

The guides 166, 168 for the transmission elements 142, 144 are formed, by way of example, in the guide part 156, in which the guide receptacle 154 for the coupling element 146 is also formed.

As can be seen from FIG. 8, the transmission elements 142, 144 are received in corresponding receptacles 170, 172 in the operating elements 132, 134, so that the operating elements 132, 134 are guided linearly via the transmission elements 142, 144 along their actuation directions 138, 140.

As mentioned above, an adjustment movement of the operating elements 132, 134 is transmitted via the coupling element 146 to a connecting element 148, which in turn engages on the valve mechanism 16.

The connecting element 148 also engages eccentrically on the coupling element 146. In particular, the connecting element 148 is rotatably mounted on the coupling element 146 at an engagement point 174. When the coupling element 146 rotates about the axis of rotation 152, the connecting element 148 is adjusted in this respect.

In the illustration according to FIG. 8, the connecting element 148 is, by way of example, displaced upwards upon actuation of the first operating element 132 and the associated rotational movement of the coupling element 146 in the counterclockwise direction, and thus the first valve body 36-1 is moved in the switching direction 38-1. In reverse, upon actuation of the second operating element 134 and the associated clockwise rotation of the coupling element 146, the connecting element 148 is displaced downwards and thus the first valve body 36-1 is moved towards the closed position, counter to the switching direction 38-1. In this way, the ventilation valve 10 can be actuated.

The suction gripping device 116 can in principle be supplied with negative pressure via a separate negative pressure supply.

However, the suction gripping device 116 is preferably supplied with negative pressure via the optional fluid guide 126 and the suction connection 124. In this context, it is possible for a control valve (not shown) to be provided on the suction gripping device 116 itself, via which control valve a negative pressure supply provided via the suction connection 124 can be selectively released (for suctioning and thus gripping an object) or can be blocked (for setting down the object).

However, it is also conceivable that such a control of the negative pressure supply to the suction gripping device 116 is realized in the operating device 108. For example, the operating mechanism 130 may additionally cooperate with a control valve (not shown) which is designed to control a negative pressure supply to the suction gripping device 116 via the fluid guide 126.

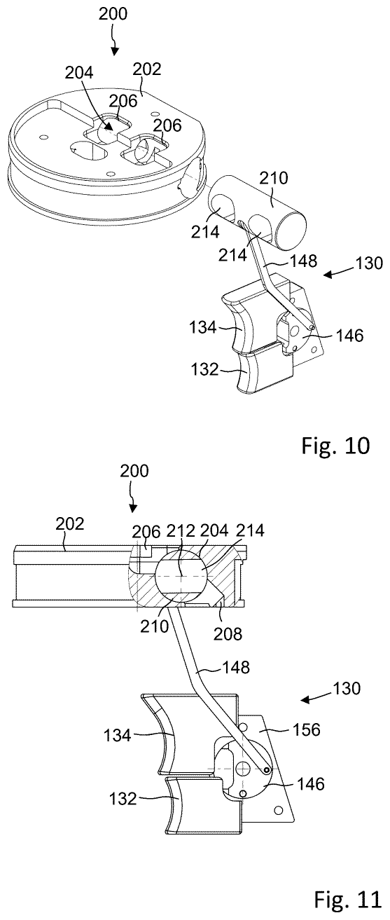

FIGS. 10 and 11 show, in a sketched representation, an embodiment by way of example of a further embodiment of a ventilation valve, which is designated overall by the reference sign 200.

FIGS. 10 and 11 also show the operating mechanism 130 by way of example as described above with reference to FIG. 7—merely for better understanding. However, the ventilation valve 200 can also be actuatable by another operating mechanism 130.

The ventilation valve 200 has a, by way of example discoid, valve housing 202 which defines a valve interior 204.

The valve housing 202 has two first openings 206 on a first side and two second openings 208 on an opposite side. In embodiments that are not shown, more or fewer first or second openings 208 may also be provided.

The first openings 206 form negative pressure openings of the ventilation valve 200. When the ventilation valve 200 is installed in a tube lifter 100, the first openings 206 are in particular fluidly connected to the tube interior of the lifting tube 102, for example via the lifting tube connection 122 of an operating device 108. In contrast, the two second openings 208 are fluidly connected to the atmosphere, in particular the ventilation connection 128, and thus form ventilation openings of the ventilation valve 200.

A valve body 210 is arranged in the valve interior 204 (in a flow path between the first openings 206 and the second openings 208). The valve body 210 is, by way of example and preferably, designed as a drum, which is mounted in the valve housing 78 so as to be rotatable about a valve body axis of rotation 212.

In particular, the valve body axis of rotation 212 is oriented inclined, preferably orthogonally, to a main flow direction from the at least one second opening 208 to the at least one first opening 206.

The valve body 210 has a radial through-opening 214 for each pair of first opening 206 and associated second opening 208.

Depending on a rotational position of the valve body 210 about the valve body axis of rotation 212, a flow path between the first openings 206 and the second openings 208 is either closed by the valve body 210 or opened by the through-openings 214. When used in a tube lifter 100, in this way the tube interior of the lifting tube 102 can be ventilated as required.

As can be seen from FIGS. 10 and 11, in a use by way of example of the ventilation valve 200 in a tube lifter 100 with the operating mechanism 130 described above, the valve body axis 212 of rotation is preferably aligned parallel to the axis of rotation 152 of the coupling element 146. In particular, the above-described connecting element 148 (transmission bracket) of the operating mechanism 132 engages on the valve body 212, so that by adjusting the connecting element 148, a rotational position of the valve body 210 about the valve body axis of rotation 212—and thus an open position of the ventilation valve 200—can be adjusted.

1. A ventilation valve for a tube lifter, comprising
a negative pressure side,
a ventilation side, in particular connected to the atmosphere,
a valve mechanism for opening and closing a flow connection between the negative pressure side and the ventilation side,
characterized in that the valve mechanism comprises a first valve body device with at least one first valve body and a second valve body device with at least one second valve body
the first valve body device being adjustable in a first switching direction proceeding from a closed position to an open position,
the second valve body device being adjustable in a second switching direction proceeding from a closed position to an open position,
the valve body devices being motion-coupled to one another in such a way that when the first valve body device moves in the first switching direction the second valve body device moves therewith in the second switching direction and vice versa,
the valve mechanism, in particular the valve body devices being designed such that, when there is a pressure difference between the negative pressure side and the ventilation side, at least in the closed position, a first force acting in the first switching direction is exerted on the first valve body device and a second force acting counter to the second switching direction is exerted on the second valve body device the valve mechanism, in particular the valve body devices being designed such that the first force and the second force differ from one another in terms of amount by a maximum of 10%, preferably a maximum of 5%, more preferably a maximum of 1%, in particular are identical.

2. The ventilation valve according to claim 1, wherein the valve body devices, in particular the valve bodies, each have first active surface portions by applying pressure to which a force is exerted on the valve body device in the respective switching direction and wherein the valve body devices in particular the valve bodies each have second active surface portions by applying pressure to which a force is exerted on the valve body device counter to the respective switching direction wherein a difference between the sum of all first active surface portions of the first valve body device and the sum of all second active surface portions of the first valve body device and a difference between the sum of all first active surface portions of the second valve body device and the sum of all second active surface portions of the second valve body device differ from one another in terms of amount by a maximum of 10%, preferably a maximum of 5%, more preferably a maximum of 1%, and are preferably identical.

3. The ventilation valve according to claim 1, wherein each valve body device in particular each valve body, is assigned at least one dedicated flow opening between the negative pressure side and the ventilation side, wherein the valve body devices cooperate with a respective valve seat in the respective closed position in order to sealingly close the at least one assigned flow opening.

4. The ventilation valve according to claim 3, wherein the valve body devices in particular the valve bodies extend through their associated at least one flow opening so that at least in an open position of the valve body device a ventilation gap between the respective valve body device and a wall defining the flow opening is formed.

5. The ventilation valve according to claim 3, wherein the negative pressure side and the ventilation side are separated from one another by a wall, wherein at least one first flow opening is formed in the wall, through which opening the at least one first valve body extends, and wherein at least one second flow opening is formed in the wall, through which opening the at least one second valve body extends, in particular wherein the wall forms a respective valve seat for the valve body devices.

6. The ventilation valve according to claim 3, wherein the valve body devices are designed in such a way, in particular the valve bodies are shaped in such a way, that during a respective adjustment movement of the valve body devices in the switching direction a flow cross-section for flows from the ventilation side to the negative pressure side, in particular the size of a ventilation gap formed between the valve body device and the valve seat, changes non-linearly, in particular increases progressively.

7. The ventilation valve according to claim 1, wherein the valve bodies taper in a direction counter to the respective switching direction in particular in a funnel-shaped or cup-shaped manner.

8. The ventilation valve according to claim 1, wherein the valve mechanism is designed such that the first switching direction and the second switching direction are oriented in opposite directions, in particular wherein the switching directions are oriented parallel to a main flow direction from the ventilation side to the negative pressure side.

9. The ventilation valve according to claim 8, wherein the first valve body device and the second valve body device are motion-coupled to one another via a rotatably mounted coupling element, in particular a coupling rod, further in particular a rocker.

10. The ventilation valve according to claim 9, wherein the valve mechanism is designed in such a way, in particular a geometric arrangement of the valve body devices and the coupling element is designed in such a way, that when the valve body devices are transferred into the closed position, one of the two valve body devices reaches its closed position before the other, in particular that valve body device whose switching direction points from the ventilation side to the negative pressure side.

11. The ventilation valve according to claim 1, wherein the valve mechanism is designed such that the first switching direction and the second switching direction are oriented parallel to one another or are identical, in particular wherein the switching directions are oriented obliquely, further in particular orthogonally, to a main flow direction from the ventilation side to the negative pressure side.

12. The ventilation valve according to claim 11, wherein the first valve body device and the second valve body device are rigidly connected to one another via a connecting element or are formed by different portions of a common valve body.

13. A tube lifter, comprising
a lifting tube with a tube interior, wherein the lifting tube can be shortened by applying negative pressure to the interior of the tube and can be lengthened again by ventilating the interior of the tube;
a ventilation valve according to any of the preceding claims, wherein the negative pressure side of the ventilation valve is fluidically connected to the tube interior of the lifting tube.

14. The tube lifter according to claim 13, further comprising an operating mechanism for actuating the ventilation valve, in particular for adjusting the valve body devices along the respective switching direction.

15. The tube lifter according to claim 14, further comprising an operating device with an operating handle, in particular that can be gripped with one hand, for operating the tube lifter, wherein the operating device is arranged at one end of the lifting tube and in particular has an end effector coupling for coupling an end effector, wherein the ventilation valve and in particular the operating mechanism are arranged on the operating device.

16. The tube lifter according to claim 15, wherein the operating mechanism comprises a first operating element and a second operating element, which are arranged on the operating device in a manually adjustable manner, wherein the operating elements are mechanically coupled to the ventilation valve via a coupling device, which in particular engages on one of the valve body devices in such a way that the valve body devices can be transferred into the open position by adjusting the first operating element in a first actuating direction and can be transferred into the closed position by adjusting the second operating element in a second actuating direction.

17. An operating device for a tube lifter, comprising
a lifting tube connection;
an end effector coupling for coupling the end effector to the operating device;
the ventilation valve according to claim 1,
an operating mechanism for actuating the ventilation valve.

18. A ventilation valve for a tube lifter, comprising
a negative pressure side,
a ventilation side, in particular connected to the atmosphere,
a valve mechanism for opening and closing a flow connection between the negative pressure side and the ventilation side,
characterized in that the valve mechanism comprises a first valve body device with at least one first valve body and a second valve body device with at least one second valve body,
the first valve body device being adjustable in a first switching direction proceeding from a closed position to an open position,
the second valve body device being adjustable in a second switching direction proceeding from a closed position to an open position,
wherein the valve body devices are motion-coupled to one another in such a way that when the first valve body device moves in the first switching direction the second valve body device moves in the second switching direction and vice versa, wherein the valve mechanism is designed such that when there is a pressure difference between the negative pressure side and the ventilation side, the first valve body device is acted upon in the first switching direction and the second valve body device is acted upon counter to the second switching direction such that the valve body devices remain in their current position as a result of the motion coupling.
